(19) United States
(12) Patent Application Publication
(10) Pub. No.: US 2005/0237888 A1
(43) Pub. Date: Oct. 27, 2005

(54) Anti-burn method

(75) Inventors: Chin-Yin Tsai, Hsin-Tien (TW); Yi-Lin Lai, Hsin-Tien (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: VIA TECHNOLOGIES, INC., Hsin-Tien (TW)

(21) Appl. No.: 11/104,649

(22) Filed: Apr. 13, 2005

Related U.S. Application Data
(60) Provisional application No. 60/561,537, filed on Apr. 13, 2004.

(51) Int. Cl. G11B 7/095; G11B 7/09

(52) U.S. Cl. 369/53.21; 369/44.13; 369/53.23

(57) ABSTRACT

The present invention provides an anti-burn method for a recording and reproducing apparatus when mechanism problem happen. The method includes: low-pass filtering a center error (CE) signal which shows the position of an optical pickup unit; detecting if the filtering CE signal is lower than a threshold value, then stopping recording and marking a stop point when the filtering CE signal is lower than the threshold value. The method further includes: continuing recording process from the stop point when the filtering CE signal is higher than the threshold value. The continuing recording process includes: preparing recording data; seeking the stop point of a disk; and continuing recording the disk from the stop point.

### CROSS REFERENCE TO RELATED APPLICATIONS

The present application claims priority to U.S. Patent Application Ser. No. 60/561,537 filed Apr. 13, 2004, hereby incorporated by reference.

### BACKGROUND OF THE INVENTION

1. Field of the Invention

The present invention is related to a recording and reproducing apparatus, more particularly to an anti-burn method for a recording and reproducing apparatus.

2. Description of the Related Art

In recent years, disk-shaped recording media such as CD-R, CD-RW, DVD-RAM, and DVD-RW are widely used due to its high capacity storage and more and more low price. As a result, recording and reproducing apparatus is public to help user writing data into a disk-shaped recording medium.

When recording a disk it is necessary to ensure there have enough preparing data to write into the disk to prevent buffer under run. Besides enlarging the cache buffer capacity, many ways such as BURN-Proof, JustLink and Seamless Link, are provided to prevent buffer under run. The common feature of the above described methods to prevent buffer under run is to monitor the cache buffer, if data within the cache buffer is not enough, then the recording and reproducing apparatus stops recording for a while until the cache buffer is refilled.

Except insufficient data in the cache buffer, some effects resulting from the mechanism such as shocks, aging, or bad design. etc. of the recording and reproducing apparatus could also cause recording damages.

For example, as we know, a sled and an actuator could help the pickup head

It is observed that the effects resulting from the mechanism of the recording and reproducing apparatus could also cause recording problem, but the methods described above such as BURN-Proof, JustLink and Seamless Link all can't overcome these recording problems caused by the mechanism.

### SUMMARY OF THE INVENTION

The present invention provides an anti-burn method of a recording and reproducing apparatus for avoiding recording error resulting from mechanism problem.

In one embodiment of the present invention, the anti-burn method of the present invention includes: low-pass filtering the center error (CE) signal which shows the position of an optical pickup unit; detecting if the filtering CE signal is lower than a threshold value; and stopping recording and marking a stop point when the filtering CE signal is lower than the threshold value.

In the embodiment of the present invention, the anti-burn method of the present invention further includes: continuing recording process from the stop point when the filtering CE signal is higher than the threshold value.

In the embodiment of the present invention, the steps of continuing recording process comprising: preparing recording data; seeking the stop point of a disk; and continuing recording the disk from the stop point.

In the embodiment of the present invention, the steps of continuing recording process further includes: comparing a recorded data to find out the stop point.

In the other one embodiment of the present invention, the anti-burn method of the present invention includes: high pass filtering a center error (CE) signal which shows the position of an optical pickup unit; detecting if the filtering CE signal is higher than a threshold value; and stopping recording and marking a stop point when the filtering CE signal is higher than the threshold value.

In the embodiment of the present invention, the anti-burn method of the present invention further includes: continuing recording process from the stop point when the filtering CE signal is lower than the threshold value.

In the embodiment of the present invention, the steps of continuing recording process comprising: preparing recording data; seeking the stop point of a disk; and continuing recording the disk from the stop point.

In the embodiment of the present invention, the steps of continuing recording process further includes: comparing a recorded data to find out the stop point.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a sled and a tracking actuator of a recording and reproducing apparatus;

FIG. 2 shows a flowchart of anti-burn method of the present invention;

FIG. 3 shows a first exemplary diagram of the present invention;

FIG. 4 shows a second exemplary diagram of the present invention.

### DETAILED DESCRIPTION

The present invention provides an anti-burn method of a recording and reproducing apparatus for avoiding recording error resulting from mechanism. In the present invention, when the recording and reproducing apparatus is suddenly shock or when unusually condition occurring due to aging or bad designed of the recording and reproducing apparatus, the recording action would be stop to avoid recording error.

A preferred embodiment is given as following to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore the present invention is not intended to be limited to the particular embodiments shown and described herein, but is to be accorded the widest herein disclosed.

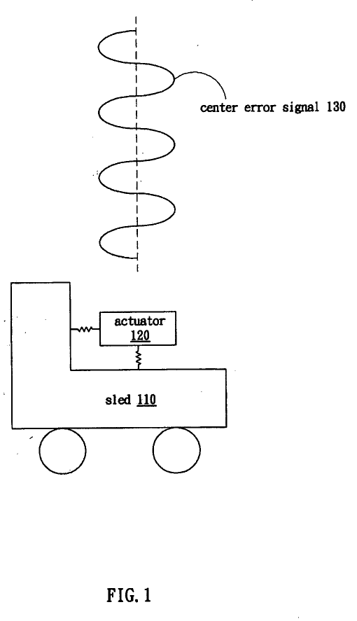

FIG. 1 shows a tracking actuator 120 on a sled 110. When reading or recording a disk, a center error (CE) signal 130 represented the movement of the tracking actuator 120 and the sled 110 is accordingly generated.

In the present invention, the CE signal 130 is taken into consideration. When recording a disk, if the recording and reproducing apparatus is suddenly shocked, or if the tracking actuator 120 or the sled 110 is malfunctioned due to aging or bad designed, the pickup head of the recording and reproducing apparatus would have run-out, and the center error signal would reflect the run-out condition.

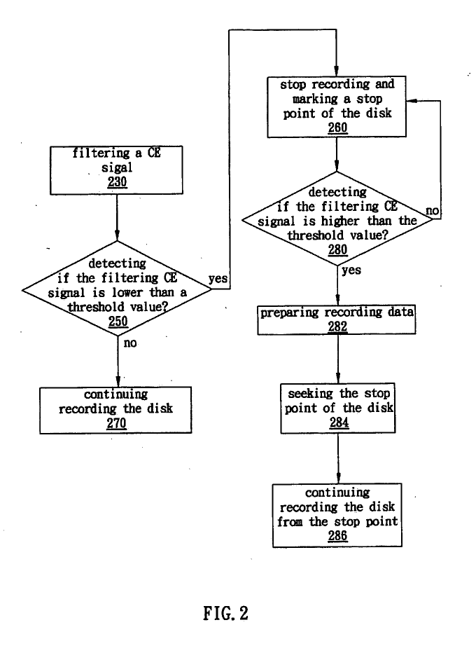

The anti-burn method of the present invention is shown in FIG. 2, including:
Step 230 low pass (high pass) filtering a CE signal which shows the position of an optical pickup head;
Step 250 detecting if the filtering CE signal is lower (higher) than a threshold value; if yes, goes to step 260, else goes to step 270
Step 260 stop recording and marking a stop point of the disk;
Step 270 continuing recording the disk;
Step 280 detecting if the filtering CE signal is higher (lower) than the threshold value; if yes, goes to step 282, else goes to step 260
Step 282 preparing recording data;
Step 284 seeking the stop point of the disk; and
Step 286 continuing recording the disk from the stop point.

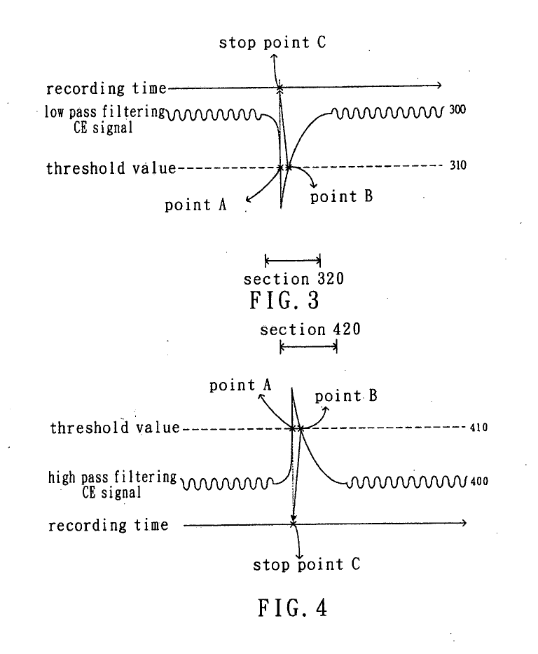

FIG. 3 is a preferred embodiment of the present invention shows a low pass filtering CE signal 300, a threshold value 310 is applied to the low pass filtering CE signal 300, and the x axis represents recording time.

When recording a disk, if the recording and reproducing apparatus is suddenly shocked or the sled or the tracking actuator is malfunctioned (for example, if the sled is aging or bad designed, it cause the larger friction and thus the sled could be motionless, but in the meanwhile the tracking actuator keeps moving), thus the pickup head on the sled and the tracking actuator would have run-out and the low pass filtering CE signal 300 would represent the situation.

In FIG. 3, under normal recording condition, the low pass filtering CE signal 300 would higher than the threshold value 310. However, if the recording and reproducing apparatus is malfunctioned due to the mechanism problem, the amplitude of low pass filtering CE signal 300 would widely decreasing (for example, the sled is motionless and the tracking keeps moving) and then increasing (for example, the sled starts to move). A section 320 shows the condition described above, it is obviously that in the section 320 a point A is the point that the low pass filtering CE signal 300 begins decreasing lower than the threshold value 310 and a point B is the point that the low pass filtering CE signal 300 begins increasing higher than the threshold value 310. In the present invention, if the point A is detected when recording, the recording and reproducing apparatus would immediately stop recording the disk and mark the stop point C. After a point B is detected, then continuing recording the disk from the stop point C. An exemplary method in the present invention to find the stop point is to compare the recorded data, but it is not limited.

The continuing recording process when the point B is detected including: at first, preparing recording data (step 282), then seeking the stop point of the disk (step 284), and continuing recording the disk from the stop point (step 286).

The region of the filtering CE signal between point A and point B is regarded as sharpness. In the present invention, if there have too much sharpness in the filtering CE signal, the recording speed of the recording and reproducing apparatus is reduced.

Furthermore, it is also practicable to replace low-pass filtering by high-pass filtering (as shown in FIG. 4). Accordingly, another threshold value is set and determining if there has a sharpness (as the example mention above, if the sled is motionless, the high pass filtering CE signal would widely increasing and then decreasing until the sled starts to move.) in high pass filtering CE signal or not. The detail process is as similar as the description above. Similarly in FIG. 4, under normal recording condition, the high pass filtering CE signal 400 would lower than the threshold value 410. However, if the recording and reproducing apparatus is malfunctioned due to the mechanism problem, the amplitude of high pass filtering CE signal 400 would widely increasing and then decreasing. A section 420 shows the condition described above, it is obviously that in the section 420 a point A is the point that the high pass filtering CE signal 400 begins increasing higher than the threshold value 410 and a point B is the point that the high pass filtering CE signal 400 begins decreasing lower than the threshold value 410. In the present invention, if the point A is detected when recording, the recording and reproducing apparatus would immediately stop recording the disk and mark the stop point C. After a point B is detected, then continuing recording the disk from the stop point C. Also, the continuing recording process when the point B is detected including: at first, preparing recording data; seeking the stop point of the disk; and continuing recording the disk from the stop point C.

As the descriptions above, the present invention provides an anti-burn method for a recording and reproducing apparatus to avoid recording error due to mechanism problem, thus the recording process is stopped and the stop point of the disk is marked. After detecting the filtering CE signal is normal, continuing recording the disk from the stop point.

Finally, those skilled in the art should appreciate that they can readily use the disclosed conception and specific embodiment as a basis for designing or modify other structures for carrying out the same purpose of the present invention without departing from the spirit and scope of the invention as defined by the appended claims.

1. An anti-burn method of a recording and reproducing apparatus, comprising:
low pass filtering a center error (CE) signal which shows the position of an optical pickup unit;
detecting if the filtering CE signal is lower than a threshold value; and
stopping recording and marking a stop point when the filtering CE signal is lower than the threshold value.

2. The anti-burn method of claim 1, further comprising:
continuing recording process from the stop point when the filtering CE signal is higher than the threshold value.

3. The anti-burn method of claim 2, wherein the steps of continuing recording process comprising:
preparing recording data;
seeking the stop point of a disk; and
continuing recording the disk from the stop point.

4. The anti-burn method of claim 3, further comprising: comparing a recorded data to find out the stop point.

5. The anti-burn method of claim 1, wherein the recording and reproducing apparatus could be a CD-RW, DVD+RW, and DVD−RW.

6. An anti-burn method of a recording and reproducing apparatus, comprising:
high pass filtering a center error (CE) signal which shows the position of an optical pickup unit;
detecting if the filtering CE signal is higher than a threshold value; and
stopping recording and marking a stop point when the filtering CE signal is higher than the threshold value.

7. The anti-burn method of claim 1, further comprising:
continuing recording process from the stop point when the filtering CE signal is lower than the threshold value.

8. The anti-burn method of claim 7, wherein the steps of continuing recording process comprising:
preparing recording data;
seeking the stop point of a disk; and
continuing recording the disk from the stop point.

9. The anti-burn method of claim 8, further comprising: comparing a recorded data to find out the stop point.

10. The anti-burn method of claim 6, wherein the recording and reproducing apparatus could be a CD-RW, DVD+RW, and DVD−RW.

11. An anti-burn method of a recording and reproducing apparatus, comprising:
low pass filtering a center error (CE) signal which shows the position of an optical pickup unit;
detecting if the filtering CE signal is lower than a threshold value;
stopping recording and marking a stop point when the filtering CE signal is lower than the threshold value; and
continuing recording process from the stop point when the filtering CE signal is higher than the threshold value.

12. The anti-burn method of claim 11, wherein the steps of continuing recording process comprising:
preparing recording data;
seeking the stop point of a disk; and
continuing recording the disk from the stop point.

13. The anti-burn method of claim 12, further comprising: comparing a recorded data to find out the stop point.

14. The anti-burn method of claim 11, wherein the recording and reproducing apparatus could be a CD-RW, DVD+RW, and DVD−RW.

15. An anti-burn method of a recording and reproducing apparatus, comprising:
high pass filtering a center error (CE) signal which shows the position of an optical pickup unit;
detecting if the filtering CE signal is higher than a threshold value;
stopping recording and marking a stop point when the filtering CE signal is higher than the threshold value; and
continuing recording process from the stop point when the filtering CE signal is lower than the threshold value.

16. The anti-burn method of claim 15, wherein the steps of continuing recording process comprising:
preparing recording data;
seeking the stop point of a disk; and
continuing recording the disk from the stop point.

17. The anti-burn method of claim 16, further comprising: comparing a recorded data to find out the stop point.

18. The anti-burn method of claim 15, wherein the recording and reproducing apparatus could be a CD-RW, DVD+RW, and DVD−RW.
